(19) United States
(12) Patent Application Publication
(10) Pub. No.: US 2025/0206962 A1
(43) Pub. Date: Jun. 26, 2025

(54) SURFACE TREATED STEEL SHEET

(71) Applicant: NIPPON STEEL CORPORATION, Tokyo (JP)

(72) Inventors: Yasuaki KAWAMURA, Tokyo (JP); Takashi FUJII, Tokyo (JP); Kunihiko TOSHIN, Tokyo (JP); Kohei UEDA, Tokyo (JP); Daichi UEDA, Tokyo (JP)

(73) Assignee: NIPPON STEEL CORPORATION, Tokyo (JP)

(21) Appl. No.: 18/852,134

(22) PCT Filed: Mar. 30, 2023
(86) PCT No.: PCT/JP2023/013368

§ 371 Date: Sep. 27, 2024

(30) Foreign Application Priority Data
Mar. 31, 2022 (JP) 2022-060595

(51) Int. Cl. C09D 5/24; C09D 7/61; C09D 163/00; C23C 2/06; C23C 22/00; C23C 28/00

(52) U.S. Cl. CPC C09D 5/24; C09D 7/61; C09D 163/00; C23C 2/06; C23C 22/00; C23C 28/32

(57) ABSTRACT

Surface treated steel sheet excellent in weldability and corrosion resistance is disclosed. The surface treated steel sheet of the present disclosure comprises a plated steel sheet having a Zn-containing plated layer, and a surface treatment layer provided on at least one main surface of the plated steel sheet, wherein the surface treatment layer has at least a paint film as an outer layer, the paint film has an average film thickness of 1.0 μm or more and 10.0 μm or less, the paint film includes a binder resin, oil absorbent, and conductive material, the binder resin includes an epoxy resin, a ratio of the epoxy resin in the binder resin is 25 vol % or more, the oil absorbent has an oil absorption of 50 ml/100 g or more, the oil absorbent has a particle diameter of half or more and equal to or less of the average film thickness, and the paint film contains the oil absorbent in 5 vol % or more.

### FIELD

The present application discloses a surface treated steel sheet.

### BACKGROUND

Surface treated steel sheet is used as a component material of automobiles etc. Surface treated steel sheet has for example a plated steel sheet having a Zn-containing plated layer and a surface treatment layer provided on at least one main surface of that plated steel sheet. In the prior art, a paint film is employed as the surface treatment layer and the types or contents of the constituents forming the paint film are adjusted to improve the weldability and corrosion resistance of the surface treated steel sheet.

For example, PTL 1 discloses a surface treated steel sheet comprised of a plated steel sheet on at least one surface of which a paint film is formed, in which paint film, a binder resin, nonoxide ceramic particles containing V, and doped zinc oxide particles are included in predetermined amounts to thereby improve the weldability and corrosion resistance of the surface treated steel sheet.

Further, PTL 2 discloses a coated steel sheet comprised of a Zn-containing plated steel sheet on at least one surface of which two or more layers of paint film are formed, in which an outermost layer of the paint film is made a predetermined thickness, the outermost layer of the paint film is made to contain a predetermined nonchromium compound, and the composition of the paint film is designed so that an electroconductivity of an immersion solution becomes the 30 μS/cm or more when immersing the coated steel sheet in an ion exchange solution under predetermined conditions, to thereby improve the corrosion resistance of the end faces of the coated steel sheet.

Further, PTL 3 discloses a coated metal material comprised of a metal material on the surface of which an organic film is provided, in which the organic film is made to contain a predetermined resin having urethane bonds and predetermined conductive particles to thereby improve the weldability and corrosion resistance of the coated metal material.

Further, PTL 4 discloses a covered metal sheet comprised of a metal sheet on the surface of which a covering layer is provided, in which the covering layer is made to contain conductive particles of a predetermined particle size to thereby improve the weldability and corrosion resistance of the covered metal sheet.

### CITATIONS LIST

### Patent Literature

[PTL 1] WO2018/092244
[PTL 2] Japanese Unexamined Patent Publication No. 2012-136025
[PTL 3] Japanese Unexamined Patent Publication No. 2004-042622
[PTL 4] Japanese Unexamined Patent Publication No. 2004-183080

### SUMMARY

### Technical Problem

The surface treated steel sheet used as a component material of automobiles etc. is required to have not only the above such weldability and corrosion resistance, but also paint film adhesion after electrodeposition. For example, as a test for evaluating the paint film adhesion after electrodeposition coating, there is the salt dipping test (SDT). According to new discoveries of the inventors, if running an SDT on a conventional surface treated steel sheet after electrodeposition coating, sometimes blisters and peeling of paint film occur at the surface after the SDT. If blisters or peeling of the paint film occurs at the surface treated steel sheet, they become a cause of red rust etc. and sufficient corrosion resistance is difficult to secure. In conventional surface treated steel sheet, suppression the occurrence of blisters and peeling of the paint film in the SDT and raising the corrosion resistance after SDT has not been sufficiently studied. As explained above, new art enabling achievement of both weldability and corrosion resistance of the surface treated steel sheet and paint film adhesion after electrodeposition coating is required.

### Solution to Problem

The present application discloses the following as means for solving the above problem.

### [Aspect 1]

A surface treated steel sheet comprising:
a plated steel sheet having a Zn-containing plated layer; and
a surface treatment layer provided on at least one main surface of the plated steel sheet,
wherein
the surface treatment layer has at least a paint film as an outer layer,
the paint film has an average film thickness of 1.0 μm or more and 10.0 μm or less,
the paint film includes a binder resin, oil absorbent, and conductive material,
the binder resin includes an epoxy resin, a ratio of the epoxy resin in the binder resin is 25 vol % or more,
the oil absorbent has an oil absorption of 50 ml/100 g or more,
the oil absorbent has a particle diameter of half or more and equal to or less of the average film thickness, and
the paint film contains the oil absorbent in 5 vol % or more.

### <Aspect 2>

The surface treated steel sheet of the aspect 1, wherein
the surface treated steel sheet has 600 gloss of 1% or more and 20% or less.

### <Aspect 3>

The surface treated steel sheet of the aspect 1 or 2, wherein
the oil absorbent is silica.

### <Aspect 4>

The surface treated steel sheet of any of the aspects 1 to 3, wherein
the conductive material is a doped oxide particle, a Si alloy containing 50 mass % or more of Si, a Si compound containing 50 mass % or more of Si or a composite of these, and
the paint film contains the conductive material in 5 vol % or more and 30 vol % or less.

### <Aspect 5>

The surface treated steel sheet according to the aspect 4, wherein
the doped oxide particle is a doped zinc oxide particle.

### <Aspect 6>

The surface treated steel sheet of the aspect 4 or 5, wherein
the Si alloy or the Si compound is ferrosilicon containing 70 mass % or more of Si.

### <Aspect 7>

The surface treated steel sheet according to any of the aspects 1 to 6, wherein
the paint film contains the oil absorbent in 10 vol % or more, and
the surface treated steel sheet has a 600 gloss of 1% or more and 15% or less.

### <Aspect 8>

The surface treated steel sheet according to any of the aspects 1 to 7, wherein
the surface treatment layer has an inorganic based or organic/inorganic composite based film as an inner layer between the paint film and the plated steel sheet, and
the inorganic based or organic/inorganic composite based film has an average film thickness of 0.1 μm or more and 1.0 μm or less.

### <Aspect 9>

A surface treated steel sheet comprising:
a plated steel sheet having a Zn-containing plated layer; and
a surface treatment layer provided on at least one main surface of the plated steel sheet,
wherein
the surface treatment layer has at least a paint film as an outer layer,
the paint film has an average film thickness of 1.0 μm or more and 10.0 μm or less,
the paint film includes a binder resin, oil absorbent, and conductive material,
the binder resin includes an epoxy resin,
a ratio of the epoxy resin in the binder resin is 25 vol % or more,
the oil absorbent has a particle diameter of half or more and equal to or less of the average film thickness,
the paint film contains the oil absorbent in 5 vol % or more, and
the surface treated steel sheet has a 600 gloss of 1% or more 20% or less.

### Advantageous Effects of Invention

The surface treated steel sheet of the present disclosure is excellent in weldability, corrosion resistance, and paint film adhesion after electrodeposition coating. For example, occurrence of blisters in the SDT after electrodeposition coating and peeling of the paint film is suppressed and excellent corrosion resistance even after the SDT is provided.

### BRIEF DESCRIPTION OF DRAWINGS

FIG. 1 is a schematic view for explaining the action and effect due to an oil absorbent having a 50 ml/100 g or more oil absorption. FIG. TA is the case where the paint film has an oil absorbent with an oil absorption of 50 ml/100 g or more present in it and FIG. 1B is the case where the paint film has a nonoil absorbent with an oil absorption of less than 50 ml/100 g present in it.

### DESCRIPTION OF EMBODIMENTS

Below, embodiments of the present invention will be explained. Note that the explanations of these are intended as just illustrations of the embodiments of the present invention. The present invention is not limited to the following embodiments.

The surface treated steel sheet according to an embodiment has a plated steel sheet having a Zn-containing plated layer and a surface treatment layer provided on at least one main surface of the plated steel sheet. The surface treatment layer has at least a paint film as an outer layer. The paint film has an average film thickness of 1.0 μm or more and 10.0 μm or less. The paint film includes a binder resin, oil absorbent, and conductive material. The binder resin includes an epoxy resin. A ratio of the epoxy resin in the binder resin is 25 vol % or more. The oil absorbent has an oil absorption of 50 ml/100 g or more. The oil absorbent has a particle diameter of half or more and equal to or less of the average film thickness. The paint film contains the oil absorbent in 5 vol % or more.

### 1. Plated Steel Sheet

The plated steel sheet, for example, has a base steel sheet and a Zn-containing plated layer provided on at least one main surface of the base steel sheet. A “main surface” referred to in the present application is a surface corresponding to the front surface or back surface of the sheet. The Zn-containing plated layer may be provided on only one main surface of the base steel sheet or may be provided on both main surfaces. Further, the Zn-containing plated layer may be provided on an entire main surface of the base steel sheet or may be provided on part of a main surface.

As the base steel sheet, ones having various chemical compositions and metallographic structures can be employed. The base steel sheet may be an ordinary steel sheet or may be a steel sheet containing chromium and other added elements. The targeted mechanical properties, shapeability, etc. may be considered to adjust the chemical composition or metallographic structure of the base steel sheet. Further, the thickness of the base steel sheet is also not particularly limited. For example, it may be 0.2 mm or more or may be 6.0 mm or less.

The Zn-containing plated layer may be one having a chemical composition known to persons skilled in the art. For example, the Zn-containing plated layer may contain Al and other added elements in addition to Zn. Further, if alloying treatment is performed, Fe etc. may also be included. As one example, the Zn-containing plated layer may be a Zn—Al—Mg alloy plated layer containing at least Al and Mg or may be a Zn—Al—Mg—Si alloy plated layer further containing Si. The content (concentrations) of these elements may also be, by mass %, Al: 0 to 60%, Mg: 0 to 10%, Si: 0 to 2%, Mn: 0 to 1%, Ni: 0 to 1%, Sb: 0 to 1%, and Fe: 0 to 20%. The Zn-containing plated layer may also be a hot dip galvannealed layer, hot dip galvanized layer, or electrogalvanized layer. The amount of deposition of the Zn-containing plated layer on the base steel sheet is not particularly limited and may be a general amount of deposition. For example, the thickness of the Zn-based plated layer may be 1 to 30 μm.

### 2. Surface Treatment Layer

The surface treatment layer is provided on at least one main surface of the plated steel sheet. The surface treatment layer may be provided on only one main surface of the plated steel sheet or may be provided at both main surfaces. Further, the surface treatment layer may be provided on an entire main surface of the plated steel sheet or may be provided at part of a main surface. The surface treatment layer can be placed over the surface of the Zn-containing plated layer in the surface of the plated steel sheet.

The surface treatment layer has at least a paint film as its outer layer. The surface treatment layer may be comprised of only the paint film or may have a two-layer structure of a paint film as an outer layer and a chemical conversion coating film as an inner layer. If the surface treatment layer has this two-layer structure, a better corrosion resistance etc. can be exhibited. On the other hand, if the surface treatment layer does not have a chemical conversion coating film as an inner layer, a better spot weldability can be exhibited.

### 2.1 Paint Film

In the surface treated steel sheet according to the present embodiment, the paint film includes a binder resin, oil absorbent, and conductive material.

### (Binder Resin)

The binder resin includes an epoxy resin. By the paint film including an epoxy resin as the binder resin, the adhesion with the electrodeposited coating film is easily improved. The epoxy resin may be an aromatic epoxy resin, may be an aliphatic epoxy resin, and may be an amine or other epoxy resin. As specific examples of the epoxy resin, for example, bisphenol A type epoxy resins, bisphenol F type epoxy resins, hydrated bisphenol A type epoxy resins, brominated bisphenol A type epoxy resins, bisphenol S type epoxy resins, phenol novolac type epoxy resins, cresol novolac type epoxy resins, bisphenol A novolac type epoxy resins, biphenyl type epoxy resins, naphthalene type epoxy resins, dicyclopentadiene type epoxy resins, triphenylmethane type epoxy resins, etc. may be mentioned. The epoxy resin may be combined with a curing agent. As the curing agent, a phenol resin and other various types of epoxy curing agents can be employed.

The binder resin may also include a resin other than an epoxy resin in addition to the epoxy resin. As the resin other than an epoxy resin, various thermosetting resins and thermoplastic resins may be mentioned. For example, at least one resin selected from a polyester resin, urethane resin, acryl resin, nylon resin, and olefin resin may be mentioned. If a polyester resin is employed as the binder resin, the polyester resin may be one having a glass transition temperature Tg of −20 to 70° C. and may be one having a number average molecular weight of 3000 to 30000. If a urethane resin is employed as the binder resin, the urethane resin may be one having Tg of 0 to 50° C. and may be one having a number average molecular weight of 5000 to 25000. If an acryl resin is employed as the binder resin, the aryl resin may be one having Tg of 0 to 50° C. and may be one having a number average molecular weight of 3000 to 25000. The binder resin may contain a curing agent other than an epoxy curing agent as well. For example, melamine resins, isocyanate resins, etc. can be employed.

It is important that the ratio of the epoxy resin in the binder resin be 25 vol % or more. That is, if the binder resin as a whole is 100 vol %, the ratio of the epoxy resin is 25 vol % or more. The ratio of the epoxy resin may also be 30 vol % or more, 40 vol % or more, 50 vol % or more, 60 vol % or more, 70 vol % or more, 80 vol % or more, or 90 vol % or more. If the ratio of the epoxy resin in the binder resin is too small, the adhesion of the paint film and the electrodeposited coating film may be insufficient and the corrosion resistance after the SDT is liable to become insufficient. The upper limit of the ratio of the epoxy resin in the binder resin is not particularly prescribed. The ratio of the epoxy resin may be 100 vol %.

The content of the binder resin in the paint film is not particularly limited. For example, it may be 50 vol % or more or 60 vol % or more and may be 90 vol % or less, 80 vol % or less, or 70 vol % or less.

### (Oil Absorbent)

The oil absorbent has the function of absorbing the resin. For example, it may have an oil absorption of 50 ml/100 g or more. As a material having the 50 ml/100 g or more oil absorption, for example, an oxide-based material such as silica, iron oxide, and titanium oxide or a barium-based material such as barium carbonate and barium sulfate etc. may be mentioned. These also function as pigments. That is, the oil absorbent may also be an oil absorbing pigment. Further, among these oil absorbents, one having a function as a rust preventer may also be employed. That is, the oil absorbent may also be an oil absorbing rust preventer. In particular, if the oil absorbent is silica, the silica exhibits a high rust preventiveness and can easily improve the corrosion resistance of the surface treated steel sheet much more easily. In the present embodiment, the oil absorbent has a particle diameter of half or more and equal to or less of the above average film thickness. Further, the oil absorbent accounts for 5 vol % or more of the paint film.

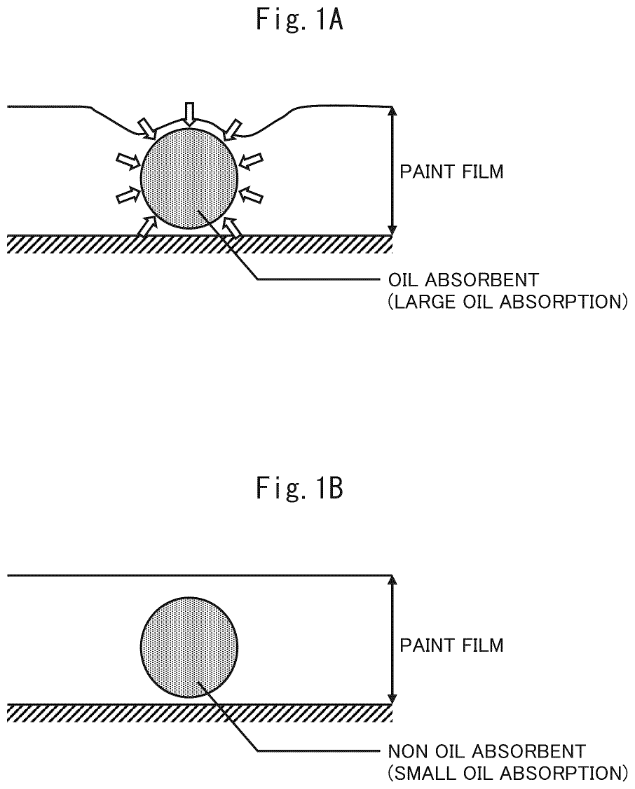

If the oil absorbent has a particle diameter of half or more and equal to or less of the average film thickness of the paint film and accounts for 5 vol % of the paint film, the following effect can be expected. That is, as shown in FIG. TA, if using a painting material containing an oil absorbent to form a paint film, at the time of drying and curing the painting material, the oil absorbent containing the solvent inside the painting material expels the solvent, then the oil absorbent absorbs the surrounding resin etc. (as shown by the white arrow marks in the figure, it is believed that the resin etc. moves to the oil absorbent) and the resin etc. becomes insufficient around the oil absorbent in state. As a result, asperities are formed at the surface of the paint film. By asperities being formed at the surface of the paint film, the surface area of the paint film increases, and the physical adhesion of the paint film and electrodeposited coating film can be improved. Further, the frequency of contact between the chemical constituents of the paint film and the electrodeposited coating film rises and the chemical adhesion of the paint film and the electrodeposited coating film can be improved. As opposed to this, if the paint film does not contain an oil absorbent (if a non-oil absorbent is contained instead of an oil absorbent being contained), if the particle diameter of the oil absorbent is too small, and/or the content of the oil absorbent is too small, the asperities formed on the surface of the paint film become smaller (FIG. 1B) and a high adhesion with the electrodeposited coating film becomes difficult to secure. Further, if the particle diameter of the oil absorbent becomes too large relative to the average film thickness of the paint film, the oil absorbent easily sticks out from the surface of the paint film and the oil absorbent sheds from the paint film and the corrosion resistance easily falls. Further, at the time of spot welding, the tips of the electrodes easily contact the oil absorbent and contact between the electrodes and the conductive material is obstructed and the spot weldability is liable to fall.

As explained above, the oil absorption of the oil absorbent is, for example, 50 ml/100 g or more. The oil absorption of the oil absorbent may also be 60 ml/100 g or more, 70 ml/100 g or more, 80 ml/100 g or more, 90 ml/100 g or more, or 100 ml/100 g or more and may also be 500 ml/100 g or less, 450 ml/100 g or less, 400 ml/100 g or less, 350 ml/100 g or less, or 300 ml/100 g or less. In the present application, the “oil absorption” of the oil absorbent before being included in the paint film can be measured based on “JIS K 5101-13-1:2004 Test Methods For Pigments—Part 13: Oil Absorption—Section 1: Refined Linseed Oil Method”. On the other hand, the “oil absorption” of the oil absorbent after being included in the paint film can be measured as in the following (1) to (3). Below, the method of measurement of the oil absorption when using “silica” as an oil absorbent will be illustrated. If using an oil absorbent including an element M instead of the element Si, it is possible to measure the oil absorption of the oil absorbent by analyzing the element M instead of the element Si in the following elemental analysis.
(1) SEM-EDX (JSM-7200F(SEM), JED-2300/F(EDS) made by JEOL) is used to examine a cross-section of the paint film to identify the silica particles contained in the paint film and find the atomic % of the elements C, O, and Si contained in the silica particles. Here, regions of a particle diameter of 1 μm or more in which the elements Si and O are distributed in 80 atomic % or more are identified as silica particles. Among those regions, in regional analysis of parts (center parts) other than outer edge parts of 0.2 μm or in point analysis of the center parts, the atomic % of the elements C, O, and Si are found. The cross-sectional analysis is performed by burying a test piece in resin, polishing it, and depositing Au.
(2) Based on the atomic %, the mass ratio of the silica part and resin part is found. At this time, the 0 of the resin part is the balance (balance 0) of the 0 part found by SEM-EDX minus the silica part (SiO₂ part). That is, the resin part is C and the balance part 0.
(3) From the mass ratio of the silica part and resin part, the volume of the resin part with respect to silica 100 g is found and the oil absorption (ml/100 g) is identified. The specific gravity of the resin is deemed 1.2.

The particle diameter of the oil absorbent is half or more (50% or more) and equal to or less (100% or less) of the average film thickness of the paint film. The particle diameter of the oil absorbent may be 55% or more, 60% or more, or 65% or more and may be less than 100%, 95% or less, 90% or less, or 85% or less of the average film thickness of the paint film. Further, in the present application, the “particle diameter” of the oil absorbent contained in the paint film is identified in the following way. That is, a surface treated steel sheet formed with a paint film is cut, and the cross-section is exposed, then polished. The thus obtained polished cross-section is examined by a scan type electron microscope to obtain an examined image. The shape of the particles of the oil absorbent present in the field in the examined image is identified. For the shape of the oil absorbent, the feret diameter in a direction along the direction of the thickness of the paint film is identified. The identified feret diameter is deemed the “particle diameter” of the oil absorbent. Further, whether the particles in the examined image are the oil absorbent can be easily judged by elemental analysis etc.

The content of the above-mentioned oil absorbent in the paint film is 5 vol % or more. The upper limit of the content of the oil absorbent can be determined considering the durability, conductivity, etc. of the paint film. If the content of the oil absorbent in the paint film is too great, the content of the binder resin or conductive material becomes relatively smaller and the durability, conductivity, etc. of the paint film may relatively fall. The content of the oil absorbent in the paint film may be 10 vol % or more, 15 vol % or more, or 20 vol % or more and may be 40 vol % or less, 35 vol % or less, or 30 vol % or less.

### (Rust Preventer)

The paint film may also contain a rust preventer. The rust preventer may be an inorganic rust preventer and may be an organic rust preventer. The rust preventor may also contain at least one element among P and V as elements exhibiting a rust preventing function. As rust preventers containing P, for example, orthophosphoric acid, metaphosphoric acid, pyrophosphoric acid, triphosphoric acid, tetraphosphoric acid, and other phosphoric acids, triammonium phosphate, diammonium hydrogen phosphate, and other ammonium salts, metal phosphates with Na, Mg, Al, K, Ca, Mn, Ni, Zn, Fe, etc., aminotri(methylenephosphonic acid), 1-hydroxyethylidene-1,1-diphosphonic acid, ethylenediamine tetra(methylenephosphonic acid), diethylene triamine penta(methylenephosphonic acid), and other phosphonic acids and their salts, phytic acid, and other organic phosphoric acids and their salts, etc. may be mentioned. Further, as rust preventers containing V, vanadium pentoxide, metavanadic acid HVO₃, ammonium metavanadate, vanadium oxytrichloride VOCl₃, vanadium trioxide V₂O₃, vanadium dioxide, vanadium oxysulfate VOSO₄, vanadium oxyacetylacetonate VO(OC(═CH₂)CH₂COCH₃)₃, vanadium acetylacetonate V(OC(═CH₂)CH₂COCH₃)₃, vanadium trichloride VCl₃, etc. may be mentioned. Further, the rust preventer may be one containing a guanidino group-containing compound, p-guanidino group-containing compound, thiocarbonyl group-containing compound, etc. The rust preventer may, for example, particles in form. The rust preventer may be water soluble or may be nonwater soluble. If the rust preventer is water soluble, for example, when the paint film is exposed to a moist environment, the rust preventer may dissolve in the water and be eluted whereby a rust preventing function of inhibiting corrosion of the plated layer can be exhibited. The content of the rust preventer in the paint film is not particularly limited. The content of the rust preventer may be greater than the content of the oil absorbent, may be less than the same, or may be the same. For example, the content of the rust preventer in the paint film may be 0 vol % or more, 0.5 vol % or more, 1.0 vol % or more, or 5.0 vol % or more and may be 15 vol % or less and or 10 vol % or less.

### (Conductive Material)

The conductive material has the function of improving the conductivity of the paint film to improve the weldability of the surface treated steel sheet. In the present application, for example, an agent having a volume resistance of 1.0×10³ Ω/cm or less can become a conductive material. As the conductive material, for example, a metal or metal compound may be mentioned. Specifically, it may be magnesium, aluminum, silicon, calcium, scandium, titanium, vanadium, chromium, manganese, iron, cobalt, nickel, copper, zinc, gallium, germanium, strontium, yttrium, zirconium, niobium, molybdenum, technetium, ruthenium, rhodium, palladium, silver, cadmium, indium, tin, and other metals; alloys of magnesium, aluminum, silicon, phosphorus, calcium, scandium, titanium, vanadium, chromium, manganese, iron, cobalt, nickel, copper, zinc, gallium, germanium, arsenic, strontium, yttrium, zirconium, niobium, molybdenum, technetium, ruthenium, rhodium, palladium, silver, cadmium, indium, tin, antimony, tellurium, etc.; or oxides and other compounds of the above metal elements. Among these as well, magnesium, aluminum, silicon, chromium, iron, nickel, zinc, tin, zinc-aluminum alloys, zinc-aluminum-magnesium alloys, zinc-aluminum-magnesium-silicon alloys, zinc-iron alloys, zinc-chromium alloys, zinc-nickel alloys, iron-nickel alloys, iron-chromium alloys, stainless steel, ferrosilicon, ferromanganese, ferrophosphorus, zinc oxide, etc. are easy to obtain. The content of the conductive material in the paint film is not particularly limited and may be suitably determined considering the targeted weldability and corrosion resistance.

In particular, if the conductive material contains a doped oxide particle, a Si alloy containing 50 mass % or more of Si, a Si alloy containing 50 mass % or more of Si, or a composite of these, it is easy to improve the conductivity (weldability) and the adhesion of the electrodeposited coating film with respect to the outer layer. In this case, the content of the conductive material in the paint film may be 5 vol % or more and 30 vol % or less.

If the conductive material is a doped oxide particle, as a specific example of the doped oxide particle, a doped zinc oxide particle may be mentioned. As the doped zinc oxide particle, for example, the zinc oxide particle having improved conductivity by doping at least one type of doping element selected from the group consisting of B, Al, Ga, In, and other elements of Group XIII of the Periodic Table and P, As, and other Group XV elements of the Periodic Table may be mentioned. If the doping element is Al or Ga, the conductivity is improved more easily. The content of the doping element may be, for example, 0.05 atom % or more or 0.1 atom % or more and may be 5 atom % or less with respect to the nondoped zinc oxide particles.

If the conductive material is a Si alloy or Si compound, as a specific example of the Si alloy or Si compound, ferrosilicon containing 70 mass % or more of Si may be mentioned. By making the paint film include ferrosilicon as a conductive material, the conductivity of the paint film and the corrosion resistance can be easily improved. In particular, ferrosilicon containing 70 mass % or more of Si is excellent in corrosion resistance and shapeability.

The conductive material may, for example, be particles in form. If the conductive material is comprised of particles in form, the average particle diameter is not particularly limited. An agent of a suitable size may be selected considering the thickness of the paint film etc. If the particle diameter of the conductive material is too small compared with the thickness of the paint film, the conductivity easily falls. On the other hand, if the particle diameter of the conductive material is too large compared with the thickness of the paint film, the conductive material will easily shed from the paint film. On this point, the particle diameter of the conductive material may be 1/10 or more or ⅕ or more of the thickness of the paint film and, further, may be 2 times or less or equal in ratio or less. The average particle diameter of the conductive material, for example, may be 0.1 μm or more, 0.3 μm or more, 0.5 μm or more, or 1.0 μm or more and, further, may be 20 μm or less, 10 μm or less, 8.0 μm or less, 6.0 μm or less, 5.0 μm or less, 4.0 m or less, or 2.5 μm or less. The “average particle diameter” of the conductive material means the average primary particle diameter if the particles in the paint film are present as primary particles and means the average secondary particle diameter if they are present agglomerated. The average particle diameter is measured in the following way. That is, a surface treated steel sheet formed with a paint film is cut, and the cross-section is exposed, then polished. The thus obtained polished cross-section is examined by a scan type electron microscope to obtain an examined image. From the conductive particles present in the field of the examined image, several are arbitrarily selected. The circle equivalent diameters of these particles are found, and their average value is regarded as the “average particle diameter”. Whether the particles in the examined image are the conductive material can be easily judged by elemental analysis etc.

### (Other Constituents)

The paint film may contain other constituents besides the constituents explained above. As the other constituents, various additives may be mentioned, such as, for example, the above-mentioned oil absorbent or pigments other than the conductive material (bright pigments designed to improve the creative appearance etc.) lubricant, defoamer, thickener, etc. The contents of these other constituents in the paint film are not particularly limited.

### (Average Film Thickness)

In the present embodiment, the paint film has an average film thickness of 1.0 μm or more and 10.0 μm or less. If the paint film is too thin, a sufficient corrosion resistance may not be obtained. On the other hand, if the coating film is too thick, the spot weldability may fall. The average film thickness of the paint film may be 2.0 μm or more or 3.0 μm or more and may be 9.0 μm or less, 7.0 μm or less, or 5.0 μm or less. The average film thickness of the paint film is measured as explained below. That is, a surface treated steel sheet formed with a paint film is cut, and the cross-section is exposed, then polished. The thus obtained polished cross-section is examined by a scan type electron microscope to obtain an examined image. The thickness of the paint film present in the field of the examined image is measured at 10 points or more at intervals of 1 μm in the planar direction of the plated steel sheet and the average value is regarded as the “average film thickness”. Alternatively, it is also possible to determine the density of the paint film from the constituents included in the paint film and then measure the weight of the paint film to identify the average film thickness of the paint film. In the present embodiment, the average film thickness identified by either method may be 1.0 μm or more and 10.0 μm or less.

### (Amount of Deposition)

The amount of deposition of the paint film is not particularly limited. For example, the amount of deposition of the paint film may be 2.0 g/m² or more, 3.5 g/m² or more, or 5.0 g/m² or more and may be 20 g/m² or less, 15 g/m² or less, or 10 g/m² or less. The amount of deposition of the paint film in the surface treated steel sheet can be measured by the weight method or cross-sectional examination. As measurement of the amount of deposition by the weight method, by using the method of measuring the initial weight of the steel sheet cut to a predetermined size, then using a solvent or a dedicated chemical able to dissolve the binder resin to remove the paint film or the method of using shot blasting using resin beads or alumina beads to remove the paint film, it is possible to calculate this by measuring the weight of the steel sheet after removal of the paint film and finding the difference of the same.

### 2.2 Chemical Conversion Coating Film

In the surface treated steel sheet according to the present embodiment, the surface treatment layer may have an inorganic based or organic/inorganic composite based film as an inner layer between the paint film and the plated steel sheet. The film may have an average film thickness of 0.1 μm or more and 1.0 μm or less. The film can also be called a “chemical conversion coating film”. That is, the surface treatment layer may be one having a two-layer structure of a paint film as an outer layer and a chemical conversion coating film as an inner layer.

### (Component Constituents)

By providing a chemical conversion coating film as an inner layer at the surface of the plated steel sheet and, further, providing the above paint film at the surface of the chemical conversion coating film, the adhesion of the paint film on the plated steel sheet etc. are improved. The chemical conversion coating film may also be a layer not substantially containing chromium (chromate-free layer). As a chromate-free treatment solution used for chemical conversion, a silica-based treatment solution mainly comprised of liquid phase silica, gaseous phase silica, a silicate, etc., a zircon-based treatment solution mainly comprised of a zircon-based compound, and mixtures of these etc. may be mentioned. The chemical conversion coating film may also contain a binder resin. For example, the chemical conversion coating film may contain at least one type of resin illustrated as a binder resin able to form the above-mentioned paint film. The content of the binder resin in the chemical conversion coating film and the contents of the constituents other than the binder resin are not particularly limited. For example, the content of the binder resin in the chemical conversion coating film may be 0 vol % or more and 50 vol % or less. Further, the contents of the constituents other than the binder resin may be 50 vol % or more and 100 vol % or less. The chemical conversion coating film as the inner layer may be an inorganic based film including an inorganic constituent as a binder or an organic/inorganic composite based film. The chemical conversion coating film may also include various additives, such as ones designed to improve the creative appearance such as a bright pigment, lubricant, defoamer, thickener, etc. The contents of these other constituents in the chemical conversion coating film are not particularly limited.

### (Average Film Thickness)

The average film thickness of the chemical conversion coating film is not particularly limited. From the viewpoint of further improving the adhesion between the plated steel sheet and paint film, the viewpoint of further improving the corrosion resistance and weldability, etc., the average film thickness of the chemical conversion coating film may be 0.1 μm or more and 1.0 μm or less. The average film thickness of the chemical conversion coating film can be measured in the same way as the average film thickness of the paint film. That is, a surface treated steel sheet formed with a chemical conversion coating film is cut, and the cross-section is exposed, then polished. The thus obtained polished cross-section is examined by a scan type electron microscope to obtain an examined image. The thickness of the chemical conversion coating film present in the field of the examined image is measured at 10 points or more at intervals of 1 μm in the planar direction of the plated steel sheet and the average value is regarded as the “average film thickness”. Alternatively, it is also possible to determine the density of the chemical conversion coating film from the constituents included in the chemical conversion coating film and then measure the weight of the chemical conversion coating film to identify the average film thickness of the chemical conversion coating film.

### (Amount of Deposition)

In the surface treated steel sheet, the amount of deposition of the chemical conversion coating film is not particularly limited. For example, if the amount of deposition of the chemical conversion coating film is 200 mg/m² or more and 2000 mg/m² or less, the corrosion resistance of the surface treated steel sheet can be easily improved more. The amount of deposition of the chemical conversion coating film at the surface treated steel sheet can be measured by fluorescent X-rays and cross-sectional analysis. Specifically, a calibration line sheet is prepared for each chemical conversion. The chemical conversion sheet and the calibration line sheet are measured by fluorescent X-rays. The amount of deposition on the prepared chemical conversion sheet is calculated by the X-ray intensities of the elements contained and the X-ray intensity of the calibration line sheet.

### 3. Effects

As explained above, in the surface treated steel sheet according to the present embodiment, due to the paint film containing the oil absorbent, asperities are formed on the surface of the paint film. Due to the asperities of the surface of the paint film, the adhesion of the paint film and the electrodeposited coating film is improved, blisters at the SDT and peeling of the paint film can be suppressed, and, further, excellent corrosion resistance can be secured even after the SDT. Further, by the average film thickness of the paint film being constant or less and the particle size of the oil absorbent in the paint film being constant or less, excellent weldability can be secured. In this way, the surface treated steel sheet according to the present embodiment is excellent in weldability, corrosion resistance, and paint film adhesion after electrodeposition coating. For example, blisters at the SDT and peeling of the paint film after electrodeposition coating are suppressed, and, further, excellent corrosion resistance is secured even after the SDT.

The surface treated steel sheet according to the present embodiment easily is given a 600 gloss of within a certain range due to the asperities formed at the surface of the paint film. That is, the surface treated steel sheet according to the present embodiment may have 600 gloss of 1% or more and 20% or less. In this way, by the 600 gloss of the surface treated steel sheet being 1% or more and 20% or less, the adhesion of the paint film and the electrodeposited coating film easily becomes more excellent. The 600 gloss of the surface treated steel sheet can change depending on the amount of the oil absorbent contained in the paint film etc. For example, in the surface treated steel sheet according to the present embodiment, the paint film may contain the above oil absorbent in 10 vol % or more and the surface treated steel sheet may have 600 gloss of 1% or more and 15% or less. The 600 gloss of the surface treated steel sheet can be measured using a glossmeter (Glossmeter GM-1 made by Suga Test Instruments Co., Ltd.).

### 4. Method of Production of Surface Treated Steel Sheet

The above-mentioned surface treated steel sheet can, for example, be produced by the following method: That is, the method of production of a surface treated steel sheet may comprise
preparing a plated steel sheet having a zinc-containing plated layer and
painting at least one main surface of the plated steel sheet with a painting material containing a binder resin, oil absorbent, and conductive material to form a paint film.

Alternatively, the method of production of a surface treated steel sheet may comprise
preparing a plated steel sheet having a zinc-containing plated layer,
chemically converting at least one main surface of the plated steel sheet to thereby form a chemical conversion coating, and
coating the surface of the chemical conversion coating with a coating material containing a binder resin, oil absorbent, and conductive material to form a coating film.

### 4.1 Preparation of Plated Steel Sheet

The plated steel sheet having a Zn-containing plated layer can, for example, be obtained through the steps of obtaining a slab by continuous casting, hot rolling the slab to obtain a hot rolled sheet, coiling the hot rolled sheet, cold rolling the hot rolled sheet to obtain a cold rolled sheet, annealing the cold rolled sheet, plating the annealed sheet, optionally skin pass rolling it, etc. The continuous casting conditions, hot rolling conditions, coiling conditions, cold rolling conditions, annealing conditions, and plating conditions may be conventionally known general conditions.

### 4.2 Chemical Conversion

In the method of production of the present disclosure, at least one main surface of the plated steel sheet obtained in the above way may be formed with a chemical conversion coating film as an inner layer. The chemical conversion can be performed by coating the various types of treatment solutions explained above on the steel sheet surface and drying them.

### 4.3 Formation of Paint Film

In the method of production of the present disclosure, the surface of the plated steel sheet obtained in the above way or the surface of the chemical conversion coating formed in the above way may be coated with a painting material including a binder resin, oil absorbent, and conductive material and dried to form a paint film as an outer layer. Here, by adjusting the type of the oil absorbent contained in the paint film, the content of the oil absorbent, the thickness of the paint film, etc., it is possible to obtain the surface treated steel sheet according to the above embodiment. Further, according to a novel finding of the present inventors, by rapid heating at the time of drying after formation of the paint film, it is possible to further improve the roughness of the paint film. In a general coated steel sheet, if rapidly heated at the time of drying the paint film, the surface of the paint film is cured before the solvent in the coating material evaporates, therefore a paint film harboring air bubbles, that is, paint film bubbles, is formed. Therefore, the general practice is to heat slowly until the solvent evaporates and then raise the heating speed. As opposed to this, according to the new findings of the inventors, if forming a paint film with an average film thickness of 1.0 μm or more and 10.0 μm or less, even if rapidly heating at the time of drying the paint film, it becomes difficult for bubbles etc. to form. By rapidly heating at the time of drying the paint film, the solvent internally present inside the oil absorbent is quickly expelled outside the system, the resin absorbed into the oil absorbent increases, and the roughness of the paint film is improved more. On this point, in the method of production of the present disclosure, the speed of temperature rise at the time of drying the paint film is preferably 20° C./s or more, more preferably 40° C./s or more. Insofar as the inventors have confirmed, if the speed of temperature rise at the time of drying the paint film is 20° C./s or more, the 600 gloss value of the surface treated steel sheet becomes less than 20%, while if the speed of temperature rise at the time of drying the coating film is 40° C./s or more, the 600 gloss value of the surface treated steel sheet becomes 17% or less. The upper limit of the speed of temperature rise is not particularly prescribed. From the viewpoint of suppressing the formation of defects such as film bubbles, further, from the viewpoint of the solvent which had been contained in the oil absorbent being sufficiently expelled and the resin part being sufficiently absorbed by the oil absorbent, the upper limit of the substantive speed of temperature rise is 100° C./s.

### 5. Modification

The surface treated steel sheet of the present disclosure may be provided with the following configuration. That is, the surface treated steel sheet according to a modification has a plated steel sheet having a Zn-containing plated layer and a surface treatment layer provided on at least one main surface of the plated steel sheet. Here, the surface treatment layer has at least a paint film as an outer layer, the paint film has an average film thickness of 1.0 μm or more and 10.0 m or less, the paint film includes a binder resin, oil absorbent, and conductive material, the binder resin includes an epoxy resin, a ratio of the epoxy resin in the binder resin is 25 vol % or more, the oil absorbent has a particle diameter of half or more and equal to or less of the average film thickness, the coating film contains the oil absorbent in 5 vol % or more, and the surface treated steel sheet has 600 gloss of 1% or more 20% or less. In the surface treated steel sheet according to the modification, for example, by including an oil absorbent of a predetermined size relative to the film thickness, the resin in the surroundings of the oil absorbent is absorbed by the oil absorbent and as a result roughness is imparted and the 600 gloss becomes 1% or more and 20% or less. The surface treated steel sheet provided with such a constitution is excellent in weldability, corrosion resistance, and paint film adhesion after electrodeposition coating. For example, occurrence of blisters in the SDT after electrodeposition coating and peeling of the paint film is suppressed and excellent corrosion resistance even after the SDT is possessed.

### EXAMPLES

Below, the present invention will be explained further while providing examples, but the present invention is not limited to the following examples. The present invention can employ various conditions so long as not departing from the gist of the present invention and achieving the object of the present invention.

### 1. Production of Surface Treated Steel Sheet

### 1.1 Preparation of Hot Dip Galvannealed Steel Sheet

The following five types of zinc-based plated steel sheets and cold rolled steel sheet were prepared, dipped in an aqueous solution of a water-based alkali degreaser (FC-301 made by Nihon Parkerizing Co., Ltd.) (2.5 mass %, 40° C.) for 2 minutes to degrease the surfaces, then rinsed and dried to obtain the base metal sheets for surface treatment.
GA: Hot dip galvannealed steel sheet (sheet thickness 0.8 mm, 10 mass % Fe, plating deposition amount 45 g/m²)
ZA1: Zn—Al—Mg ternary hot dip galvanized steel sheet (Zn-11% Al-3% Mg-0.2% Si) (sheet thickness 0.8 mm, 10 mass % Fe, plating deposition amount 60 g/m²)
ZA2: Zn—Al—Mg ternary hot dip galvanized steel sheet (Zn-6% Al-3% Mg) (sheet thickness 0.8 mm, 10 mass % Fe, plating deposition amount 60 g/m²)
ZL: Electro Zn-10 mass % Ni alloy plated steel sheet (sheet thickness 0.8 mm, plating deposition amount 40 g/m²)
GI: Hot dip galvanized steel sheet (sheet thickness 0.8 mm, plating deposition amount 60 g/m²)
EG: Electrogalvanized steel sheet (sheet thickness 0.8 mm, plating deposition amount 40 g/m²)
CR: Cold rolled steel sheet (sheet thickness 0.8 mm, no plating)

### 1.2 Formation of Inner Layer (Chemical Conversion Coating Film)

Next, the following treatment solution S for chemical conversion use is prepared. The treatment solution is coated on the above-mentioned base metal sheet while changing the diameter of the bar coater so as to give the amount of deposition shown in Tables 3 and 4. After that, the sheet was dried in a hot air oven until the peak temperature at the metal sheet surface became 70° C. It was then air dried to form a chemical conversion coating on the surface of the metal sheet. The average film thickness of the chemical conversion coating film was 0.2 μm.
S: Treatment solution for chemical conversion use of Nv10% comprised of a Zr compound, silane coupling agent, silica fine particles, and a polyester resin.

### 1.3 Formation of Outer Layer (Paint Film)

Next, a coating film having each of the compositions (vol %) shown in Tables 1 and 2 was formed by mixing the constituents so as to obtain a solids concentration similar to Tables 1 and 2 to thereby prepare a painting composition for formation of a paint film. The composition was coated on the base metal sheet or on the chemical conversion coating film while changing the diameter of the bar coater or dilution rate to obtain the amounts of deposition shown in Tables 3 and 4 and the sheet was dried using an oven under conditions giving a peak maximum temperature of 200° C. to thereby form a paint film as an outer layer. The average film thickness of the paint film was the thickness shown in Tables 3 and 4 (μm). Further, the constituents included in the painting composition are shown below:

### (Oil Absorbing Pigment)

SC: Calcium ion exchanged silica (Ca exchange rate 9%) (oil absorption 300 ml/100 g, particle diameter 2 μm)
Si1: Silica (oil absorption 250 ml/100 g, particle diameter 2 μm)
Si2: Silica (oil absorption 100 ml/100 g, particle diameter 1, 2, 3, 5, or 10 μm)
Si3: Silica (oil absorption 50 ml/100 g, particle diameter 2 μm)
FeO: Iron oxide (oil absorption 60 ml/100 g, particle diameter 2 μm)

### (Non-Oil Absorbing Pigment)

PA: Aluminum tripolyphosphate (oil absorption 10 ml/100 g, particle diameter 2 μm)
PM: Magnesium phosphate (oil absorption 30 ml/100 g, particle diameter 2 μm)
Si4: Silica (oil absorption 30 ml/100 g, particle diameter 2 μm)

### (Conductivity Pigment)

FeSi: Ferrosilicon particles (average particle diameter 3 μm, 70 mass % or more of Si contained)
SUS: SUS particles (average particle diameter 4 μm)
ZnO: Doped zinc oxide particles (23-Kt made by Hakusuitec Co., Ltd., average particle diameter 0.5 μm)

### (Binder Resin)

B1: Epoxy resin (Adeka Resin EP-4100 made by ADEKA)
B2: Polyester resin (Vylon 200 made by Vylon)
B3: Epoxy resin (Adeka Resin EM-0461N made by ADEKA)
B4: Polyester resin (Vylonal MD1480 made by Vylon)
B5: Urethane resin (Superflex 150 made by DKS Co., Ltd.)
B6: Melamine resin (Cymel 325 made by allnex)

### 2. Tests for Evaluation of Performance

The surface treated steel sheets were subjected to the following tests for evaluation of performance.

### 2.1 Warm Salt Dipping Test (SDT)

### (Advance Preparations)

Each surface treated steel sheet was conditioned on its surface at room temperature for 20 seconds using a surface conditioning treatment agent “PREPALENE-X made by Nihon Parkerizing Co., Ltd. Further, it was chemically converted (phosphate treatment) using a chemical conversion solution (zinc phosphate treatment solution) “Palbond 3020 (product name)” made by Nihon Parkerizing Co., Ltd. The temperature of the chemical conversion solution was made 43° C. The hot pressed material was dipped in the chemical conversion solution for 120 seconds, then rinsed and dried. After the above chemical conversion treatment (phosphate treatment), a cationic electrodeposition coating made by Nippon Paint Co., Ltd. was deposited by electrodeposition by slope energization of a voltage of 160V and further was baked on by a baking temperature of 170° C. for 20 minutes. The average of the thickness of the electrodeposition coating film after the electrodeposition coating was 10 μm in all samples.

### (Corrosion Resistance at SDT)

After the above electrodeposition coating, the end faces of the surface treated steel sheet were sealed by tape and the sheet was immersed in a 3% NaCl aqueous solution having a 50° C. temperature for 500 hours. The sample taken out after the immersion test was dried and visually measured for the area ratio of blisters present at the electrodeposition coating film. In the corrosion resistance test, in the case of “3”, it was judged that a certain extent of corrosion resistance was possessed while in the case of “4” or “5”, it was judged that the corrosion resistance was excellent. The results are shown in Tables 3 and 4.
1: Blister area ratio from evaluated surface of 50% or more
2: Blister area ratio from evaluated surface of 5% or more and less than 50%
3: Blister area ratio from evaluated surface of 1% or more and less than 5%
4: Blisters formed from evaluated surface, but less than 1%
5: No blisters formed

### 2.2. Post SDT Corrosion Resistance Test

Each surface treated steel sheet coated by electrodeposition after the warm salt dipping test was subjected to a cycle corrosion test under the following cycle conditions for 120 cycles.

### (Cycle Conditions)

A salt spray test (SST, 5% NaCl, 35° C. atmosphere) was conducted for 2 hr, with drying (60° C.) for 2 hr, and wetting (50° C., 98% RH) for 4 hr as 1 cycle.

After that, the state of corrosion was examined from a flat part and the following evaluation points were assigned. In the corrosion resistance test, in the case of “3”, “4”, or “5”, the corrosion resistance was judged to be excellent. The results are shown in Tables 3 and 4,
1: White rust area ratio from evaluated surface of 50% or more or red rust confirmed to occur from evaluated surface
2: White rust area ratio from evaluated surface of 10% or more and less than 50%
3: White rust area ratio from evaluated surface of 5% or more and less than 10%
4: White rust area ratio from evaluated surface of 1% or more and less than 5%
5: White rust area ratio from evaluated surface of less than 1%

### 2.3 Spot Weldability

Each surface treated steel sheet was subjected to an electrode life test of spot welding using R40 CF type Cr—Cu electrodes with a tip diameter of 5 mm at a clamping force of 1.96 kN, weld current of 8 kA, and weld time of 12 cycles/50 Hz. The number of welds until right before the nugget size became less than 3 t (“t” is sheet thickness) was found. The level of the spot weldability was evaluated using the following evaluation points. In the weldability test, in the case of “4”, “5”, or “6”, the weldability was judged to be excellent. The results are shown in Tables 3 and 4.
1: Nugget not formed and not even one point could be welded or number of welds of less than 10
2: Number of welds of 10 or more and less than 50
3: Number of welds of 50 or more and less than 200
4: Number of welds of 200 or more and less than 1000
5: Number of welds of 1000 or more and less than 2000
6: Number of welds of 2000 or more

### 2.4 60° Gloss

Each of the surface treated steel sheet was measured for 60° gloss by a Micro Tri Gloass made by BYK. The measured 600 gloss value (%) is shown in Tables 3 and 4.

TABLE 1

| | | | | | | | | Rust preventing pigment | | | | | |
|---|---|---|---|---|---|---|---|---|---|---|---|---|---|
| | Binder resin | | | | | | | Oil absorbing or non-oil | | | Oil absorbing or non-oil | | |
| | Resin 1 | | | | | | | absorbing pigment 1 | | | absorbing pigment 1 | | |
| | (epoxy) | | Resin 2 | | Resin 3 | | Epoxy | | Particle. | | | Particle. | |
| No | Type | Ratio | Type | Ratio | Type | Ratio | ratio | Type | size | Ratio | Type | size | Ratio |
| 1 | B1 | 79 | | | | | 100 | Si2 | 2 | 1 | | | |
| 2 | B1 | 77 | | | | | 100 | Si2 | 2 | 3 | | | |
| 3 | B1 | 75 | | | | | 100 | Si2 | 2 | 5 | | | |
| 4 | B1 | 70 | | | | | 100 | Si2 | 2 | 10 | | | |
| 5 | B1 | 65 | | | | | 100 | Si2 | 2 | 15 | | | |
| 6 | B1 | 60 | | | | | 100 | Si2 | 2 | 20 | | | |
| 7 | B1 | 55 | | | | | 100 | Si2 | 2 | 25 | | | |
| 8 | B1 | 50 | | | | | 100 | Si2 | 2 | 30 | | | |
| 9 | B1 | 75 | | | | | 100 | Si2 | 2 | 20 | | | |
| 10 | B1 | 70 | | | | | 100 | Si2 | 2 | 20 | | | |
| 11 | B1 | 65 | | | | | 100 | Si2 | 2 | 20 | | | |
| 12 | B1 | 55 | | | | | 100 | Si2 | 2 | 20 | | | |
| 13 | B1 | 65 | | | | | 100 | Si2 | 2 | 20 | | | |
| 14 | B1 | 65 | | | | | 100 | Si2 | 2 | 20 | | | |
| 15 | B1 | 65 | | | | | 100 | Si2 | 2 | 20 | | | |
| 16 | B1 | 70 | | | | | 100 | Si2 | 2 | 20 | | | |
| 17 | B1 | 65 | | | | | 100 | Si2 | 2 | 20 | | | |
| 18 | B1 | 60 | | | | | 100 | Si2 | 2 | 20 | | | |
| 19 | B1 | 65 | | | | | 100 | Si2 | 2 | 20 | | | |
| 20 | B1 | 65 | | | | | 100 | Si2 | 2 | 20 | | | |
| 21 | B1 | 60 | | | | | 100 | Si1 | 2 | 20 | | | |
| 22 | B1 | 60 | | | | | 100 | Si3 | 2 | 20 | | | |
| 23 | B1 | 60 | | | | | 100 | Si4 | 2 | 20 | | | |
| 24 | B1 | 60 | | | | | 100 | FeO | 2 | 20 | | | |
| 25 | B1 | 60 | | | | | 100 | PA | 2 | 20 | | | |
| 26 | B1 | 60 | | | | | 100 | PM | 2 | 20 | | | |
| 27 | B1 | 60 | | | | | 100 | SC | 2 | 20 | | | |

| | Conductivity pigment | | | | | |
|---|---|---|---|---|---|---|
| | Conductivity pigment 1 | | | Conductivity pigment 2 | | |
| | | Particle. | | | Particle. | |
| No | Type | size | Ratio | Type | size | Ratio |
| 1 | FeSi | 3 | 20 | | | |
| 2 | FeSi | 3 | 20 | | | |
| 3 | FeSi | 3 | 20 | | | |
| 4 | FeSi | 3 | 20 | | | |
| 5 | FeSi | 3 | 20 | | | |
| 6 | FeSi | 3 | 20 | | | |
| 7 | FeSi | 3 | 20 | | | |
| 8 | FeSi | 3 | 20 | | | |
| 9 | FeSi | 3 | 5 | | | |
| 10 | FeSi | 3 | 10 | | | |
| 11 | FeSi | 3 | 15 | | | |
| 12 | FeSi | 3 | 25 | | | |
| 13 | FeSi | 3 | 15 | ZnO | 0.5 | 5 |
| 14 | FeSi | 3 | 15 | ZnO | 0.5 | 10 |
| 15 | FeSi | 3 | 15 | ZnO | 0.5 | 15 |
| 16 | ZnO | 0.5 | 10 | | | |
| 17 | ZnO | 0.5 | 15 | | | |
| 18 | ZnO | 0.5 | 20 | | | |
| 19 | FeSi | 3 | 15 | SUS | 4 | 10 |
| 20 | ZnO | 0.5 | 15 | SUS | 4 | 10 |
| 21 | FeSi | 3 | 20 | | | |
| 22 | FeSi | 3 | 20 | | | |
| 23 | FeSi | 3 | 20 | | | |
| 24 | FeSi | 3 | 20 | | | |
| 25 | FeSi | 3 | 20 | | | |
| 26 | FeSi | 3 | 20 | | | |
| 27 | FeSi | 3 | 20 | | | |

TABLE 2

| | | | | | | | | Rust preventing pigment | | | | | | | | | | | |
|---|---|---|---|---|---|---|---|---|---|---|---|---|---|---|---|---|---|---|---|
| | | | | | | | | Oil | | | Oil | | | | | | | | |
| | | | | | | | | absorbing or | | | absorbing or | | | | | | | | |
| | | | | | | | | non-oil | | | non-oil | | | Conductivity pigment | | | | | |
| | | | | | | | | absorbing | | | absorbing | | | Conductivity | | | Conductivity | | |
| | Binder resin | | | | | | | pigment 1 | | | pigment 1 | | | pigment 1 | | | pigment 2 | | |
| | Resin 1 | | | | | | | | Par- | | | Par- | | | Par- | | | Par- | |
| | (epoxy) | | Resin 2 | | Resin 3 | | Epoxy | | ticle. | | | ticle. | | | ticle. | | | ticle. | |
| No | Type | Ratio | Type | Ratio | Type | Ratio | ratio | Type | size | Ratio | Type | size | Ratio | Type | size | Ratio | Type | size | Ratio |
| 28 | | | B2 | 48 | B6 | 12 | 0 | Si2 | 2 | 20 | | | | FeSi | 3 | 20 | | | |
| 29 | B1 | 5 | B2 | 44 | B6 | 11 | 8 | Si2 | 2 | 20 | | | | FeSi | 3 | 20 | | | |
| 30 | B1 | 10 | B2 | 40 | B6 | 10 | 17 | Si2 | 2 | 20 | | | | FeSi | 3 | 20 | | | |
| 31 | B1 | 15 | B2 | 36 | B6 | 9 | 25 | Si2 | 2 | 20 | | | | FeSi | 3 | 20 | | | |
| 32 | B1 | 20 | B2 | 32 | B6 | 8 | 33 | Si2 | 2 | 20 | | | | FeSi | 3 | 20 | | | |
| 33 | B1 | 30 | B2 | 24 | B6 | 6 | 50 | Si2 | 2 | 20 | | | | FeSi | 3 | 20 | | | |
| 34 | B1 | 40 | B2 | 16 | B6 | 4 | 67 | Si2 | 2 | 20 | | | | FeSi | 3 | 20 | | | |
| 35 | B1 | 50 | B2 | 8 | B6 | 2 | 83 | Si2 | 2 | 20 | | | | FeSi | 3 | 20 | | | |
| 36 | B1 | 70 | | | | | 100 | Si2 | 2 | 10 | Si1 | 2 | 10 | FeSi | 3 | 20 | | | |
| 37 | B1 | 70 | | | | | 100 | Si2 | 2 | 10 | Si3 | 2 | 10 | FeSi | 3 | 20 | | | |
| 38 | B1 | 70 | | | | | 100 | Si2 | 2 | 10 | Si4 | 2 | 10 | FeSi | 3 | 20 | | | |
| 39 | B1 | 70 | | | | | 100 | Si2 | 2 | 10 | FeO | 2 | 10 | FeSi | 3 | 20 | | | |
| 40 | B1 | 70 | | | | | 100 | Si2 | 2 | 10 | PA | 2 | 10 | FeSi | 3 | 20 | | | |
| 41 | B1 | 70 | | | | | 100 | Si2 | 2 | 10 | PM | 2 | 10 | FeSi | 3 | 20 | | | |
| 42 | B1 | 70 | | | | | 100 | Si2 | 2 | 10 | SC | 2 | 10 | FeSi | 3 | 20 | | | |
| 43 | B1 | 75 | | | | | 100 | Si2 | 1 | 5 | | | | FeSi | 3 | 20 | | | |
| 44 | B1 | 75 | | | | | 100 | Si2 | 3 | 5 | | | | FeSi | 3 | 20 | | | |
| 45 | B1 | 75 | | | | | 100 | Si2 | 5 | 5 | | | | FeSi | 3 | 20 | | | |
| 46 | B1 | 75 | | | | | 100 | Si2 | 10 | 5 | | | | FeSi | 3 | 20 | | | |
| 47 | B3 | 60 | | | | | 100 | Si2 | 2 | 1 | | | | ZnO | 0.5 | 20 | | | |
| 48 | B3 | 60 | | | | | 100 | Si2 | 2 | 5 | | | | ZnO | 0.5 | 20 | | | |
| 49 | B3 | 60 | | | | | 100 | Si2 | 2 | 10 | | | | ZnO | 0.5 | 20 | | | |
| 50 | B3 | 60 | | | | | 100 | Si2 | 2 | 20 | | | | ZnO | 0.5 | 20 | | | |
| 51 | B3 | 48 | B6 | 12 | | | 80 | Si2 | 2 | 20 | | | | ZnO | 0.5 | 20 | | | |
| 52 | B3 | 40 | B4 | 16 | B6 | 4 | 67 | Si2 | 2 | 20 | | | | ZnO | 0.5 | 20 | | | |
| 53 | B3 | 40 | B5 | 20 | | | 67 | Si2 | 2 | 20 | | | | ZnO | 0.5 | 20 | | | |
| 54 | | | B4 | 48 | B6 | 12 | 0 | Si2 | 2 | 20 | | | | FeSi | 3 | 20 | | | |
| 55 | | | B5 | 60 | | | 0 | Si2 | 2 | 20 | | | | FeSi | 3 | 20 | | | |

TABLE 3

| | | | | | | Oil absorbing or | | | | | |
|---|---|---|---|---|---|---|---|---|---|---|---|
| | | | | | | non-oil absorbing | | Warm | | | |
| | | Chemical conversion | | Painting | Paint | pigment particle | | salt water | | 60° | |
| | Steel | coating film | | material | film | diameter/Paint | | corrosion | Weld- | gloss | |
| | sheet | Yes/no | Thickness | no. | thickness | film thickness | Blisters | resistance | ability | value | Remarks |
| 1 | GA | Yes | 0.2 | 1 | 3.0 | 0.67 | 3 | 1 | 5 | 30 | Comp. ex. |
| 2 | GA | Yes | 0.2 | 2 | 3.0 | 0.67 | 3 | 2 | 5 | 25 | Comp. ex. |
| 3 | GA | Yes | 0.2 | 3 | 3.0 | 0.67 | 4 | 3 | 5 | 19 | Ex. |
| 4 | GA | Yes | 0.2 | 4 | 3.0 | 0.67 | 4 | 4 | 5 | 15 | Ex. |
| 5 | GA | Yes | 0.2 | 5 | 3.0 | 0.67 | 5 | 5 | 5 | 14 | Ex. |
| 6 | GA | Yes | 0.2 | 6 | 3.0 | 0.67 | 5 | 5 | 5 | 13 | Ex. |
| 7 | GA | Yes | 0.2 | 7 | 3.0 | 0.67 | 5 | 5 | 5 | 13 | Ex. |
| 8 | GA | Yes | 0.2 | 8 | 3.0 | 0.67 | 5 | 5 | 4 | 13 | Ex. |
| 9 | GA | Yes | 0.2 | 9 | 3.0 | 0.67 | 5 | 5 | 3 | 16 | Ex. |
| 10 | GA | Yes | 0.2 | 10 | 3.0 | 0.67 | 5 | 5 | 4 | 18 | Ex. |
| 11 | GA | Yes | 0.2 | 11 | 3.0 | 0.67 | 5 | 5 | 5 | 12 | Ex. |
| 12 | GA | Yes | 0.2 | 12 | 3.0 | 0.67 | 5 | 5 | 5 | 13 | Ex. |
| 13 | GA | Yes | 0.2 | 13 | 3.0 | 0.67 | 5 | 5 | 4 | 13 | Ex. |
| 14 | GA | Yes | 0.2 | 14 | 3.0 | 0.67 | 5 | 5 | 5 | 13 | Ex. |
| 15 | GA | Yes | 0.2 | 15 | 3.0 | 0.67 | 5 | 5 | 5 | 13 | Ex. |
| 16 | GA | Yes | 0.2 | 16 | 3.0 | 0.67 | 5 | 5 | 3 | 18 | Ex. |
| 17 | GA | Yes | 0.2 | 17 | 3.0 | 0.67 | 5 | 5 | 4 | 17 | Ex. |
| 18 | GA | Yes | 0.2 | 18 | 3.0 | 0.67 | 5 | 5 | 5 | 17 | Ex. |
| 19 | GA | Yes | 0.2 | 19 | 3.0 | 0.67 | 5 | 5 | 5 | 15 | Ex. |
| 20 | GA | Yes | 0.2 | 20 | 3.0 | 0.67 | 5 | 5 | 5 | 15 | Ex. |
| 21 | GA | Yes | 0.2 | 21 | 3.0 | 0.67 | 5 | 5 | 5 | 10 | Ex. |
| 22 | GA | Yes | 0.2 | 22 | 3.0 | 0.67 | 4 | 4 | 5 | 18 | Ex. |
| 23 | GA | Yes | 0.2 | 23 | 3.0 | 0.67 | 3 | 2 | 5 | 25 | Comp. ex. |
| 24 | GA | Yes | 0.2 | 24 | 3.0 | 0.67 | 3 | 3 | 5 | 18 | Ex. |
| 25 | GA | Yes | 0.2 | 25 | 3.0 | 0.67 | 2 | 2 | 5 | 30 | Comp. ex. |
| 26 | GA | Yes | 0.2 | 26 | 3.0 | 0.67 | 2 | 2 | 5 | 30 | Comp. ex. |
| 27 | GA | Yes | 0.2 | 27 | 3.0 | 0.67 | 3 | 4 | 5 | 15 | Ex. |
| 28 | GA | Yes | 0.2 | 28 | 3.0 | 0.67 | 2 | 2 | 5 | 13 | Comp. ex. |
| 29 | GA | Yes | 0.2 | 29 | 3.0 | 0.67 | 2 | 2 | 5 | 13 | Comp. ex. |
| 30 | GA | Yes | 0.2 | 30 | 3.0 | 0.67 | 2 | 2 | 5 | 13 | Comp. ex. |
| 31 | GA | Yes | 0.2 | 31 | 3.0 | 0.67 | 3 | 3 | 5 | 13 | Ex. |
| 32 | GA | Yes | 0.2 | 32 | 3.0 | 0.67 | 3 | 3 | 5 | 13 | Ex. |
| 33 | GA | Yes | 0.2 | 33 | 3.0 | 0.67 | 4 | 3 | 5 | 13 | Ex. |
| 34 | GA | Yes | 0.2 | 34 | 3.0 | 0.67 | 5 | 4 | 5 | 13 | Ex. |
| 35 | GA | Yes | 0.2 | 35 | 3.0 | 0.67 | 5 | 5 | 5 | 13 | Ex. |
| 36 | GA | Yes | 0.2 | 36 | 3.0 | 0.67 | 5 | 5 | 5 | 12 | Ex. |
| 37 | GA | Yes | 0.2 | 37 | 3.0 | 0.67 | 5 | 5 | 5 | 16 | Ex. |

TABLE 4

| | | | | | | Oil absorbing or non-oil | | Warm | | | |
|---|---|---|---|---|---|---|---|---|---|---|---|
| | | Chemical conversion | | Painting | Paint | absorbing pigment | | salt water | | 60° | |
| | Steel | coating film | | Material | film | particle diameter/ | | corrosion | Weld- | gloss | |
| | sheet | Yes/no | Thickness | no. | thickness | Paint film thickness ratio | Blisters | resistance | ability | value | Remarks |
| 38 | GA | Yes | 0.2 | 38 | 3.0 | 0.67 | 4 | 4 | 5 | 18 | Ex. |
| 39 | GA | Yes | 0.2 | 39 | 3.0 | 0.67 | 5 | 4 | 5 | 16 | Ex. |
| 40 | GA | Yes | 0.2 | 40 | 3.0 | 0.67 | 4 | 4 | 5 | 18 | Ex. |
| 41 | GA | Yes | 0.2 | 41 | 3.0 | 0.67 | 4 | 4 | 5 | 18 | Ex. |
| 42 | GA | Yes | 0.2 | 42 | 3.0 | 0.67 | 4 | 5 | 5 | 18 | Ex. |
| 43 | GA | Yes | 0.2 | 43 | 3.0 | 0.33 | 2 | 2 | 5 | 25 | Comp. ex. |
| 44 | GA | Yes | 0.2 | 44 | 3.0 | 1.00 | 4 | 3 | 4 | 18 | Ex. |
| 45 | GA | Yes | 0.2 | 45 | 3.0 | 1.67 | 2 | 3 | 3 | 8 | Comp. ex. |
| 46 | GA | Yes | 0.2 | 46 | 3.0 | 3.33 | 2 | 2 | 3 | 7 | Comp. ex. |
| 47 | GA | Yes | 0.2 | 47 | 3.0 | 0.67 | 3 | 1 | 5 | 30 | Comp. ex. |
| 48 | GA | Yes | 0.2 | 48 | 3.0 | 0.67 | 4 | 3 | 5 | 19 | Ex. |
| 49 | GA | Yes | 0.2 | 49 | 3.0 | 0.67 | 4 | 4 | 5 | 15 | Ex. |
| 50 | GA | Yes | 0.2 | 50 | 3.0 | 0.67 | 5 | 5 | 5 | 13 | Ex. |
| 51 | GA | Yes | 0.2 | 51 | 3.0 | 0.67 | 5 | 5 | 5 | 13 | Ex. |
| 52 | GA | Yes | 0.2 | 52 | 3.0 | 0.67 | 5 | 5 | 5 | 13 | Ex. |
| 53 | GA | Yes | 0.2 | 53 | 3.0 | 0.67 | 5 | 5 | 5 | 13 | Ex. |
| 54 | GA | Yes | 0.2 | 54 | 3.0 | 0.67 | 1 | 2 | 5 | 13 | Comp. ex. |
| 55 | GA | Yes | 0.2 | 55 | 3.0 | 0.67 | 2 | 2 | 5 | 13 | Comp. ex. |
| 56 | GA | No | — | 6 | 3.0 | 0.67 | 4 | 4 | 5 | 13 | Ex. |
| 57 | GA | Yes | 0.1 | 6 | 3.0 | 0.67 | 4 | 5 | 5 | 13 | Ex. |
| 58 | GA | Yes | 0.5 | 6 | 3.0 | 0.67 | 5 | 5 | 5 | 13 | Ex. |
| 59 | GA | Yes | — | 6 | 3.0 | 0.67 | 5 | 5 | 5 | 13 | Ex. |
| 60 | ZL | Yes | 0.2 | 6 | 3.0 | 0.67 | 5 | 5 | 5 | 13 | Ex. |
| 61 | GI | Yes | 0.2 | 6 | 3.0 | 0.67 | 3 | 4 | 5 | 13 | Ex. |
| 62 | EG | Yes | 0.2 | 6 | 3.0 | 0.67 | 4 | 4 | 5 | 13 | Ex. |
| 63 | CR | Yes | 0.2 | 6 | 3.0 | 0.67 | 2 | 1 | 5 | 13 | Comp. ex. |
| 64 | GA | Yes | 0.2 | 6 | 0.5 | 4.00 | 2 | 2 | 5 | 13 | Comp. ex. |
| 65 | GA | Yes | 0.2 | 43 | 1.0 | 1.00 | 3 | 3 | 5 | 11 | Ex. |
| 66 | GA | Yes | 0.2 | 43 | 2.0 | 0.50 | 4 | 3 | 5 | 16 | Ex. |
| 67 | GA | Yes | 0.2 | 43 | 3.0 | 0.33 | 2 | 2 | 5 | 21 | Comp. ex. |
| 68 | GA | Yes | 0.2 | 45 | 5.0 | 1.00 | 5 | 4 | 3 | 17 | Ex. |
| 69 | GA | Yes | 0.2 | 45 | 7.0 | 0.71 | 5 | 4 | 3 | 18 | Ex. |
| 70 | GA | Yes | 0.2 | 46 | 10.0 | 1.00 | 5 | 5 | 3 | 19 | Ex. |
| 71 | GA | Yes | 0.2 | 46 | 15.0 | 0.67 | 5 | 5 | 2 | 22 | Comp. ex. |
| 72 | ZA1 | Yes | 0.2 | 6 | 3.0 | 0.00 | 5 | 5 | 4 | 13 | Ex. |
| 73 | ZA2 | Yes | 0.2 | 6 | 3.0 | 0.00 | 5 | 5 | 4 | 14 | Ex. |

### 3. Results and Considerations

From the results shown in Tables 1 to 4, the following will be understood.

In each of Nos. 1 and 2, the paint film contained an oil absorbing pigment having an oil absorption of 50 ml/100 g, but the content was less than 5 vol %, therefore the resin etc. was not sufficiently absorbed in the oil absorbing pigment at the time of formation of the paint film, and the surface of the paint film was smoothed. As a result, sufficient adhesion could not be obtained between the paint film and electrodeposited coating film and the corrosion resistance after the SDT was also inferior.

In No. 23, the Si4 contained in the paint film was a non-oil absorbing pigment with an oil absorption of less than 50 ml/100 g, the resin etc. was not absorbed in the non-oil absorbing pigment at the time of formation of the paint film, and the surface of the paint film was smoothed. As a result, sufficient adhesion could not be obtained between the paint film and electrodeposited coating film and the corrosion resistance after the SDT was also inferior.

In each of Nos. 25 and 26, the PA or PM contained in paint film was a non-oil absorbing pigment with an oil absorption of less than 50 ml/100 g, the resin etc. was not absorbed in the non-oil absorbing pigment at the time of formation of the paint film, and the surface of the paint film was smoothed. As a result, a large amount of blisters occurred at the time of the SDT and the corrosion resistance after the SDT was also inferior.

In No. 28, the binder resin forming the paint film did not contain an epoxy resin, therefore the adhesion of the paint film and the electrodeposited coating film was poor. As a result, a large amount of blisters occurred at the time of the SDT and the corrosion resistance after the SDT was also inferior.

In each of Nos. 29 and 30, the ratio of the epoxy resin in the binder resin forming the paint film was too small, therefore the adhesion of the paint film and the electrodeposited coating film was poor. As a result, a large amount of blisters occurred at the time of the SDT and the corrosion resistance after the SDT was also inferior.

In No. 43, the particle size of the oil absorbing pigment was 0.33 time (⅓) or less than half of the thickness of the paint film, so the resin etc. was not sufficiently absorbed in the oil absorbing pigment at the time of formation of the paint film and the surface of the paint film was smoothed. As a result, sufficient adhesion could not be obtained between the paint film and electrodeposited coating film, a large amount of blisters occurred at the time of the SDT, the corrosion resistance after the SDT was also inferior.

In each of Nos. 45 and 46, the particle size of the oil absorbing pigment 1.67 times and 3.33 times the thickness of the paint film or equal to or more than the same, therefore the state became one where the oil absorbing pigment easily shed from the paint film. Further, the oil absorbing pigment excessively absorbed the resin in the paint film whereby the thickness of the resin became excessively small. As a result, a large amount of blisters occurred at the time of the SDT. Further, in No. 46, the tips of the electrodes ended up contacting the oil absorbing pigment at the time of spot welding and conduction to the conductivity pigment was obstructed whereby the spot weldability fell.

In No. 47, in the same way as No. 1, the vol % of the oil absorbing pigment included in the paint film was less than 5%, therefore as a result the corrosion resistance after the SDT greatly deteriorated.

In each of Nos. 54 and 55, in the same way as No. 28, the binder resin forming the paint film did not include any epoxy resin, therefore the adhesion between the paint film and the electrodeposited coating film was poor. As a result, a large amount of blisters occurred at the time of the SDT and the corrosion resistance after the SDT deteriorated.

In No. 63, steel sheet not having a Zn-based plated layer was used, therefore as result a large amount of blisters occurred at the time of the SDT and also the corrosion resistance after the SDT greatly deteriorated.

In No. 64, the thickness of the paint film was less than 1.0 μm, therefore the state became one where the oil absorbing pigment easily shed from the paint film. Further, the paint film was too thin, therefore sufficient corrosion was difficult to be secured. As a result, a large amount of blisters occurred at the time of the SDT and the corrosion resistance after the SDT was also inferior.

In No. 67, in the same way as No. 43, the particle size of the oil absorbing pigment was 0.33 time (⅓) the thickness of the paint film or less than half of the same, therefore at the time of formation of the paint film, the resin etc. was not sufficiently absorbed at the oil absorbing pigment and the surface of the paint film was smoothed. As a result, sufficient adhesion could not be obtained between the paint film and electrodeposited coating film, and a large amount of blisters occurred at the time of the SDT.

In No. 71, the thickness of the paint film was 15.0 μm or too great, therefore the result became inferior spot weldability.

As opposed to this, in each of Nos. 3 to 22, 24, 27, 31 to 42, 44, 48 to 53, 56 to 62, 65, 66, 68 to 70, 72, and 73, (1) the paint film had a 1.0 μm or more and 10.0 μm or less average film thickness, (2) the paint film contained a binder resin, oil absorbent, and conductivity pigment, (3) the binder resin included an epoxy resin, (4) the ratio of the epoxy resin in the binder resin was 25 vol % or more, (5) the oil absorbent had a 50 ml/100 g or more oil absorption, (6) the oil absorbent had a particle size of half or more or equal to or less the average film thickness, and (7) the paint film contained the oil absorbent in 5 vol % or more, therefore had an excellent weldability and also was able to be suppressed in blisters at the time of the SDT and was excellent in corrosion resistance after the SDT.

Further, the binder resins B1 and B2 are solvent-based resins while the binder resins B3 to B5 are water-based resins. As clear from the above results, the art of the present disclosure can also be applied to either a solvent-based resin and a water-based resin.

From the above results, a surface treated steel sheet satisfying the following requirements can be said to have excellent weldability and corrosion resistance and to be excellent also in paint film adhesion after electrodeposition coating.

A surface treated steel sheet comprising:
a plated steel sheet having a Zn-containing plated layer; and
a surface treatment layer provided on at least one main surface of the plated steel sheet,
wherein
the surface treatment layer has at least a paint film as an outer layer,
the paint film has an average film thickness of 1.0 μm or more and 10.0 μm or less,
the paint film includes a binder resin, oil absorbent, and conductive material,
the binder resin includes an epoxy resin,
a ratio of the epoxy resin in the binder resin is 25 vol % or more,
the oil absorbent has an oil absorption of 50 ml/100 g or more,
the oil absorbent has a particle diameter of half or more and equal to or less of the average film thickness, and
the paint film contains the oil absorbent in 5 vol % or more.

### 4. Study Regarding Drying Conditions of Painting Material

After the steel sheet (above-mentioned GA) was formed with a chemical conversion coating in the same way as the above, a painting material for formation of a paint film (above-mentioned Painting Material No. 3 or 6) was coated on the chemical conversion coating by a bar coater and was dried using an oven under conditions giving a maximum peak temperature of 200° C. to form a paint film as an outer layer. At this time, the drying conditions of the painting material were changed to confirm the effect of the drying conditions on the roughness of the paint film surface. Specifically, the speed of temperature rise at the time of drying was controlled to 5.0° C./s, 10.0° C./s, 25.0° C./s, 50.0° C./s, or 100.0° C./s. The following Table 5 shows the types of the steel sheets, the thicknesses of the chemical conversion coatings, the types of the painting materials, the thicknesses of the paint films, the speeds of temperature rise at the time of drying the painting materials, and the ratios of the particle diameters of the oil absorbing pigments and thicknesses of the paint films.

The above obtained surface treated steel sheets were evaluated for performance in the same way as the above. The results are shown in the following Table 5.

TABLE 5

| | | Chemical | | | | | Oil absorbing | | Warm | | | |
|---|---|---|---|---|---|---|---|---|---|---|---|---|
| | | conversion | | | | Speed | pigment particle | | salt | | | |
| | | coating film | | Painting | Paint | of | diameter/Paint | | water | | 60° | |
| | Steel | | Thick- | material | film | temp. | film thickness | | corrosion | Weld- | gloss | |
| | sheet | Yes/no | ness | no. | thickness | rise | ratio | Blisters | resistance | ability | value | Remarks |
| 74 | GA | Yes | 0.2 | 3 | 3.0 | 5.0 | 0.67 | 3 | 3 | 5 | 23 | Ref. ex. |
| 75 | GA | Yes | 0.2 | 3 | 3.0 | 10.0 | 0.67 | 3 | 3 | 5 | 20 | Ex. |
| 76 | GA | Yes | 0.2 | 3 | 3.0 | 25.0 | 0.67 | 4 | 3 | 5 | 19 | Ex. |
| 77 | GA | Yes | 0.2 | 3 | 3.0 | 50.0 | 0.67 | 4 | 4 | 5 | 17 | Ex. |
| 78 | GA | Yes | 0.2 | 3 | 3.0 | 100.0 | 0.67 | 3 | 3 | 4 | 14 | Ex. |
| 79 | GA | Yes | 0.2 | 6 | 3.0 | 5.0 | 0.67 | 4 | 4 | 5 | 18 | Ex. |
| 80 | GA | Yes | 0.2 | 6 | 3.0 | 10.0 | 0.67 | 4 | 5 | 5 | 15 | Ex. |
| 81 | GA | Yes | 0.2 | 6 | 3.0 | 25.0 | 0.67 | 5 | 5 | 5 | 13 | Ex. |
| 82 | GA | Yes | 0.2 | 6 | 3.0 | 50.0 | 0.67 | 5 | 5 | 5 | 12 | Ex. |
| 83 | GA | Yes | 0.2 | 6 | 3.0 | 100.0 | 0.67 | 4 | 4 | 4 | 10 | Ex. |

As clear from the results shown in Table 5, it is learned that the higher the speed of temperature rise at the time of drying the painting material, the greater the roughness of the paint film and the smaller the 600 gloss value of the surface treated steel sheet. As explained above, by controlling not only the type of the paint film, but also the drying conditions at the time of formation of the paint film, it is possible to make the 600 gloss of the surface treated steel sheet fall more and can be said to make the paint film adhesion after electrodeposition coating be improved more.

1. A surface treated steel sheet comprising:
a plated steel sheet having a Zn-containing plated layer; and
a surface treatment layer provided on at least one main surface of the plated steel sheet,
wherein
the surface treatment layer has at least a paint film as an outer layer,
the paint film has an average film thickness of 1.0 μm or more and 10.0 μm or less,
the paint film includes a binder resin, oil absorbent, and conductive material,
the binder resin includes an epoxy resin,
a ratio of the epoxy resin in the binder resin is 25 vol % or more,
the oil absorbent has an oil absorption of 50 ml/100 g or more,
the oil absorbent has a particle diameter of half or more and equal to or less of the average film thickness, and
the paint film contains the oil absorbent in 5 vol % or more.

2. The surface treated steel sheet according to claim 1, wherein
the surface treated steel sheet has 60° gloss of 1% or more and 20% or less.

3. The surface treated steel sheet according to claim 1, wherein
the oil absorbent is silica.

4. The surface treated steel sheet according to claim 1, wherein
the conductive material is a doped oxide particle, a Si alloy containing 50 mass % or more of Si, a Si compound containing 50 mass % or more of Si or a composite of these, and
the paint film contains the conductive material in 5 vol % or more and 30 vol % or less.

5. The surface treated steel sheet according to claim 4, wherein
the doped oxide particle is a doped zinc oxide particle.

6. The surface treated steel sheet according to claim 4, wherein
the Si alloy or the Si compound is ferrosilicon containing 70 mass % or more of Si.

7. The surface treated steel sheet according to claim 1, wherein
the paint film contains the oil absorbent in 10 vol % or more, and
the surface treated steel sheet has a 60° gloss of 1% or more and 15% or less.

8. The surface treated steel sheet according to claim 1, wherein
the surface treatment layer has an inorganic based or organic/inorganic composite based film as an inner layer between the paint film and the plated steel sheet, and
the inorganic based or organic/inorganic composite based film has an average film thickness of 0.1 μm or more and 1.0 μm or less.

9. A surface treated steel sheet comprising:
a plated steel sheet having a Zn-containing plated layer; and
a surface treatment layer provided on at least one main surface of the plated steel sheet,
wherein
the surface treatment layer has at least a paint film as an outer layer,
the paint film has an average film thickness of 1.0 μm or more and 10.0 μm or less,
the paint film includes a binder resin, oil absorbent, and conductive material,
the binder resin includes an epoxy resin,
a ratio of the epoxy resin in the binder resin is 25 vol % or more,
the oil absorbent has a particle diameter of half or more and equal to or less of the average film thickness,
the paint film contains the oil absorbent in 5 vol % or more, and
the surface treated steel sheet has a 60° gloss of 1% or more 20% or less.
